(19) United States
(12) Patent Application Publication
(10) Pub. No.: US 2026/0111701 A1
(43) Pub. Date: Apr. 23, 2026

(54) METHODS AND PROCESSORS FOR RELATIONAL REASONING FROM TEXT

(71) Applicant: HUAWEI TECHNOLOGIES CO., LTD., Shenzhen (CN)

(72) Inventors: Ge ZHANG, Markham (CA); Mhd Ali ALOMRANI, Brampton (CA); Hongjian GU, Montreal (CA); Yaochen HU, Montreal (CA); Yingxue ZHANG, Markham (CA)

(21) Appl. No.: 19/074,860

(22) Filed: Mar. 10, 2025

Related U.S. Application Data
(60) Provisional application No. 63/708,374, filed on Oct. 17, 2024.

(51) Int. Cl. G06N 3/042

(52) U.S. Cl. CPC G06N 3/042

(57) ABSTRACT

Methods and processors are disclosed. The method includes acquiring an input indicative of a Relational Question-Answering (RQA) problem, generating an instance graph based on the input, generating an intermediate output indicative of one or more reasoning paths in the instance graph and generating, based on the input and the intermediate output, an output indicative of one or more potential answers to the RQA problem.

### CROSS-REFERENCE

The present application claims priority on U.S. Provisional Patent Application No. 63/708,374, entitled “METHODS AND PROCESSORS FOR RELATIONAL REASONING FROM TEXT USING GRAPHS AND LARGE LANGUAGE MODELS”, filed on Oct. 17, 2024, and the contents of which are incorporated herein by reference in its entirety.

### FIELD

The present technology is generally related relational reasoning, and more specifically to methods and processors for relational reasoning from text.

### BACKGROUND

Large Language Models (LLMs) possess vast semantic knowledge but often struggle with reasoning tasks that require using evidence, arguments, and logic to arrive at conclusions or make decisions (e.g., robot planning). An example reasoning task is relational question-answering (RQA) where the input is a textual “story” s and the output is a target “relation” t (e.g., daughter). The story describes entities and their relations (e.g., John visited his son Jack) and includes a question which asks for an implicit relation between 2 entities in the story (e.g., what should Jack call Jennifer?). The question can have multiple possible answers due to ambiguities.

Given the structured nature of most reasoning tasks, the input problem can be manifested as an instance graph g where the nodes and edges represent the entities and relations within the task description, respectively.

A first type of relational reasoning technique is called an LLM Prompting-based reasoning. Prompting-based methods directly input the problem into the LLM and rely on knowledge stored in its internal parameters to solve the problem instance.

In an article entitled “Language Models are Few-Shot Learners”, authored by Brown et al. and published in 2020 in Proceedings of the 34th International Conference on Neural Information Processing Systems, and the content of which is incorporated herein by reference in its entirety, there is disclosed In-context learning which adds few-shot examples within the prompt. The input prompt includes input story s, and a set c=[s₁,t₁,s₂,t₂, . . . ] of example problems (stories sᵢ and answers tᵢ) to better understand the task at hand before outputting the answer t=LLM(s, c).

In an article entitled “Chain-of-Thought Prompting Elicits Reasoning in Large Language Models”, authored by Wei et al. and published in 2022 in Proceedings of the 36th International Conference on Neural Information Processing Systems, and the content of which is incorporated herein by reference in its entirety, there is disclosed Chain-of-thought (CoT) prompting which adds reasoning steps before deriving the answer to the few-shot examples. That is, the input prompt includes input story s, and a set c=[s₁, r₁, t₁, s₂, r₂, t₂, . . . ] of example problems which include stories sᵢ, reasoning explanation rᵢ and corresponding answers tᵢ. A reasoning rᵢ includes a step-by-step problem-solving explanation that derives the answer. This encourages the LLM to “think” and output explanations along with the answer: t, r=LLM(s, c).

A second type of relational reasoning technique is called Model-based reasoning which involves designing and training task-specific neural networks for the RQA problem.

In an article entitled “SPARTQA: A Textual Question Answering Benchmark for Spatial Reasoning”, authored by Mirzaee et. al. and published in 2021 in Conference of the North American Chapter of the Association for Computational Linguistics: Human Language Technologies, and the content of which is incorporated herein by reference in its entirety, there is disclosed a synthetic dataset for spatial reasoning where the task is to predict the spatial relation between 2 objects. This problem is cast as a sequence classification problem where a BERT transformer model predicts the relation type t given the story s: t=BERT(s). The BERT model is finetuned on the synthetic dataset. A BERT model is disclosed in an article entitled “BERT: Pre-training of Deep Bidirectional Transformers for Language Understanding”, authored by Devlin et al. and published in 2019 in Proceedings of the 2019 Conference of the North American Chapter of the Association for Computational Linguistics: Human Language Technologies, the content of which is incorporated herein by reference in its entirety.

In an article entitled “CLUTRR: A Diagnostic Benchmark for Inductive Reasoning from Text”, authored by Sinha et al. and published in 2019 in Conference on Empirical Methods in Natural Language Processing and the 9th International Joint Conference on Natural Language Processing, the content of which is incorporated herein by reference in its entirety, introduces a synthetic dataset, CLUTRR, for kinship reasoning where the task is to predict the kinship relation between 2 persons in a given story. This problem is cast as an edge classification task where a GNN model is used to predict the target relation t given the graph g manifested by the story (persons and kinship relations as nodes and edges, respectively): t=GNN(g). The graph g is assumed to be available. The GNN model is disclosed in an article entitled “Semi-Supervised Classification with Graph Convolutional Networks”, authored by Kipf et al. and published in 2017 in International Conference on Learning Representations, the content of which is incorporated herein by reference in its entirety.

A third type of relational reasoning technique is called Neuro-symbolic reasoning which uses a combination of LLMs and symbolic solvers.

In an article entitled “Logic-LM: Empowering Large Language Models with Symbolic Solvers for Faithful Logical Reasoning”, authored by Pan et al. and published in 2023 in Findings of the Association for Computational Linguistics (EMNLP), the content of which is incorporated herein by reference in its entirety, there is disclosed methods to address a variety of logical reasoning problems, such as constraint-satisfaction and first-order logic problems using LLMs. The framework is composed of three components: problem formulator, symbolic reasoner, and result interpreter. First, given the problem description s, the problem formulator translates it to a solver-specific symbolic language using an LLM: p=LLM(s). The problem formulation p includes all the rules, facts, entities, and queries necessary to solve the problem. Next, the symbolic solver will search and output a solution: o=solver(p). Logic-LLM also utilizes a self-refinement strategy. If the solver returns an execution error due to incorrect syntax in p, the problem formulator is called again and asked to refine the problem formulation. The choice of the symbolic solver depends on the problem at hand and is defined by a human expert. Finally, since the output o may not be human readable, the result interpreter will translate the results returned from the symbolic solver back to a natural language answer: t=LLM(o).

In an article entitled “Coupling Large Language Models with Logic Programming for Robust and General Reasoning from Text”, authored by Yang et. al. and published in 2023 in Findings of the Association for Computational Linguistics (ACL), the content of which is incorporated herein by reference in its entirety, there is disclosed methods that use answer set programs as generic symbolic solvers for tackling a variety of RQA tasks. The framework is composed of two phases: extraction and reasoning. In the extraction phase, an LLM extract all the facts f and entities e from the textual problem s: f, e=LLM(s). This phase can involve several LLM calls to extract all facts and entities from the given textual problem. In the reasoning phase, the ASP solver searches and outputs an answer: t=solver(p), where p=(f, e, k, q). The facts and entities come from the extraction phase while the problem-specific rule-set k and query q are usually known and defined by the user.

### SUMMARY

Developers have devised methods and devices for overcoming at least some drawbacks present in prior art solutions.

In the context of the present technology, a “graph” is a structured knowledge base for storing real-world data. A graph is represented by a set of nodes V and edges E. Nodes represent objects (e.g., person) while edges represent a relation (e.g., kinship relation) from one object to another object. Both edges and nodes can have attributes (e.g., name, age, relation type, etc.). A path on the graph is formed by a sequence of edges which are connected by mutual object between adjacent edges. For example, the edges (John, spouse, Betty), (Betty, daughter, Jennifer) and (Jennifer, mother, Alice) form a connected path of length 3 that connects nodes John, Betty, Jennifer and Alice. Graphs can be used to model complex relationship in real-world systems such as molecules, social networks, transaction systems, etc.

In the context of the present technology, a Large Language Models (LLM) is a neural network model designed to understand and generate human language by converting (sub)words into vector representations. Primarily trained for text generation, LLMs predict the next most probable (sub)word based on a given input (i.e., prompt), a process known as auto-regressive language modeling. LLMs can perform a variety of language tasks such as question-answering. For instance, given a prompt like “Who invented the light bulb? ”, the model can produce the answer “Thomas Edison” by repeatedly generating words based on the input prompt. The most advanced LLMs contain billions of trainable parameters and are trained on vast text corpora from various sources, including the Internet. LLMs can be customized for specific tasks through two main methods: fine-tuning, which involves adjusting the model's internal parameters, and/or prompt-engineering, which involves modifying the input prompt without changing the model's parameters.

In the context of the present technology, “symbolic solvers” are a collection of methods that operate on a symbolic (i.e., human-readable) representation of knowledge. Unlike LLMs, such solvers do not store knowledge in vector representations but rather rely on a set of problem-specific rules (e.g. (A, son, B), (B, son, C)->(A, grandson, C)) represented in a well-defined symbolic language (e.g., ASP1, PDDL2, etc.). Given a problem formulation consisting of a set of entities e (e.g., John, Jack), facts f (e.g. (John, brother, Jack)), rules k, and query q, the symbolic solver performs inference to output the answer for the query. The details of the inference stage are dependent on the symbolic language, problem formulation, and solver at hand.

In the context of the present technology, an “answer set programming” (ASP) is a symbolic language for knowledge representation and reasoning. ASP programs consist of facts (e.g., Boolean facts), rules (e.g., conditional statements), and the question (query). Standard ASP symbolic solvers include Clasp and ASSAT.

In the context of the present technology, “planning domain definition language” (PDDL) is a human-readable format for planning problems that gives a description of the possible states of the world, the set of possible actions, a specific initial state of the world, and a specific set of desired goals. Action descriptions include the prerequisites of the action and the effects of the action. To compute the answer, this problem formulation can be fed into any compatible symbolic solver such as the fast-forward planner.

In the context of the present technology, “Relational Question-Answering (RQA) problem” refers to a question-answering task where the goal is to determine the relationship between two entities mentioned in a textual story. The relationship is not explicitly stated and must be inferred by reasoning over the context and connections described in the narrative (e.g., “What is Alice's relation to Bob?” when the story mentions that Alice is the daughter of Bob's sister).

In the context of the present technology, “Instance Graph” refers to a structured representation of an RQA problem, where nodes represent entities and edges represent relationships between them. It captures the relational structure of the story as a graph.

In the context of the present technology, “Intermediate Output” refers to the data generated during the reasoning process that is not the final answer but aids in deriving it. It typically includes reasoning paths extracted from the instance graph.

In the context of the present technology, “Reasoning Paths” refers to sequences of edges in the instance graph that connect the entities relevant to the RQA problem. These paths represent potential relational explanations that can be used to infer the answer.

In the context of the present technology, “Reasoner” refers to a component that evaluates the reasoning paths to infer possible answers to the RQA problem. It uses either internal knowledge or explicit graph traversal to derive the answer.

In the context of the present technology, “LLM-based Reasoner” refers to a reasoner that uses a Large Language Model (LLM) to evaluate reasoning paths and infer answers. It relies on the internal knowledge of the LLM for relational reasoning.

In the context of the present technology, “Graph Reasoner” refers to a reasoner that uses explicit graph traversal to evaluate reasoning paths and infer answers. It navigates through nodes and edges in a knowledge graph to determine relationships.

In the context of the present technology, “Domain Knowledge Graph” refers to a pre-built graph representing domain-specific relationships, such as kinship or spatial relations. It contains nodes and edges that explicitly define relationships relevant to a particular problem domain.

In the context of the present technology, “Personalized Knowledge Graph” refers to a graph containing user-specific information, such as personal contacts or preferences. It is used to answer questions by reasoning over data relevant to an individual user.

In the context of the present technology, “Kinship Domain Graph” refers to a domain knowledge graph that represents family relationships, such as parent, sibling, or cousin. It explicitly defines kinship relations for reasoning about familial connections.

Developers of the present technology have realized that at least some relational reasoning techniques are known for relational question-answering (RQA). Developers have also realized that known relationship reasoning techniques have one or more disadvantages. For example, at least some known techniques may require extensive training on large RQA datasets. This training process must be done for every RQA problem type separately (e.g., kinship, spatial, etc.). In contrast, some embodiments of the present technology may operate without extensive fine-tuning, allowing them to work out-of-the-box for different RQA tasks, thereby reducing the dependency on large datasets. In another example, at least some known techniques may require extensive LLM prompting. Some techniques may need to call the LLM multiple times before solving the problem. LLM prompting can be computationally demanding and/or too slow for the user experience. In contrast, some embodiments of the present technology may use a single LLM call to extract an instance graph, optimizing computational efficiency and speeding up inference. In a further example, at least some known techniques may require expert rules to be written by human experts. The rules define the constraints and logic of the problem (e.g. (A, brother, B)+(B, sister, C)->(A, brother, C)). Complex problems can require hundreds of pre-defined rules. In contrast, some embodiments of the present technology may eliminate the need for expert-defined rules by employing a hybrid pipeline that dynamically infers relationships using both LLMs and graph reasoning. In an additional example, at least some known techniques may not render interpretable outputs and therefore do not provide reasoning “thoughts” in the output, making it difficult to interpret the answer in case of error. In contrast, some embodiments of the present technology may enhance interpretability by generating and displaying reasoning paths used to derive each answer, thereby making the decision-making process more transparent. In yet other examples, at least some known techniques may exhibit hallucinations since they use LLMs for problem extraction/translation and/or reasoning. LLMs can make extraction errors which propagate down the pipeline, causing incorrect answers or solver failures (i.e., no solution). Some embodiments of the present technology may address these issues by generating multiple potential answers and employing conflict resolution mechanisms, effectively isolating errors and minimizing the impact of hallucinations.

In some embodiments, a processor may be configured to perform a single call to an LLM for generating a solution to the RQA problem. In other embodiments, a processor may generate and/or trigger display of one or more reasoning paths that were used to arrive at the one or more potential answer, for the purpose of interpretability. In further embodiments, a processor may be configured to, rather than extracting a problem formulation in a solver-specific symbolic language, extract an instance graph g which represents the structure of the RQA problem. The instance graph g can be used with a variety of downstream solvers and/or tasks. In further embodiments, a processor may generate more than one potential answers. In case of conflict or error due to LLM hallucinations, the processor may be configured to isolate errors and/or output all possible solutions. In additional embodiments, a processor may not necessarily require finetuning on a particular dataset and/or may not necessarily use of a symbolic solver. A variety of off-the-shelf LLMs can be used by the processor.

In some embodiments, a pipeline executed by the processor comprise a graph extraction operation. Given a textual RQA problem s, the extraction module extracts an instance graph g=(V, E) representing the problem and the query q which asks for the implicit relation between 2 nodes v₁,v₂∈V. The entire extraction process can be performed in one LLM call. This is possible because the LLM is instructed to identify entities, extract all relations between entities, and construct the instance graph in one pass. Unlike traditional methods that require multiple LLM calls for each step (e.g., separate calls for entity extraction, relation extraction, and graph construction), this approach minimizes computation time, reduces cost, and ensures consistent outputs by avoiding variations between multiple calls. This also streamlines the pipeline, making it more efficient and scalable for real-time applications.

In some embodiments, a pipeline executed by the processor may comprise a reasoning path extraction operation. The processor identifies all possible paths between v₁ and v₂. Each path is known as a reasoning path since it helps infer the answer. Any path can be used to infer the implicit relation between the two nodes.

In some embodiments, a pipeline executed by the processor may comprise a reasoning operation. A reasoner is employed to infer the relations given each extracted reasoning path separately. If no extraction errors have occurred and the input problem is well-defined, then all paths should infer the same answer. Otherwise, all possible answers are aggregated to produce the final list.

At least some implementations of the present technology comprise use in the context of question-answering system where reasoning performance is desired. For example, AI assistants can use the pipeline executed by the processor to enhance their reasoning performance on edge devices (e.g., smartphones).

In at least one aspect of the present technology, there is provided a computer-implemented method executable by a processor, comprising: acquiring an input indicative of a Relational Question-Answering (RQA) problem; generating, using a Large Language Model (LLM), an instance graph based on the input; generating an intermediate output indicative of one or more reasoning paths in the instance graph; and generating, using a reasoner and based on the input and the intermediate output, an output indicative of one or more potential answers to the RQA problem.

In some embodiments of the method, the reasoner is an LLM-based reasoner.

In some embodiments of the method, the reasoner is a graph reasoner.

In some embodiments of the method, the method comprises generating a knowledge graph for use by the graph reasoner.

In some embodiments of the method, the knowledge graph is at least one of a domain knowledge graph and a personalized knowledge graph.

In some embodiments of the method, the personalized knowledge graph is generated using user data specific to a given user.

In some embodiments of the method, the domain knowledge graph is a kinship domain graph.

In some embodiments of the method, the input is acquired from a user device, and the method further comprises displaying the output on the user device.

In some embodiments of the method, the displaying further comprises displaying the intermediate output on the user device.

In some embodiments of the method, the generating the instance graph is executed using a single call to the LLM.

In at least one aspect of the present technology, there is provided a processor configured to: acquire an input indicative of a Relational Question-Answering (RQA) problem; generate, using a Large Language Model (LLM), an instance graph based on the input; generate an intermediate output indicative of one or more reasoning paths in the instance graph; and generate, using a reasoner and based on the input and the intermediate output, an output indicative of one or more potential answers to the RQA problem.

In some embodiments of the processor, the reasoner is an LLM-based reasoner.

In some embodiments of the processor, the reasoner is a graph reasoner.

In some embodiments of the processor, the processor is further configured to generate a knowledge graph for use by the graph reasoner.

In some embodiments of the processor, the knowledge graph is at least one of a domain knowledge graph and a personalized knowledge graph.

In some embodiments of the processor, the personalized knowledge graph is generated using user data specific to a given user.

In some embodiments of the processor, the domain knowledge graph is a kinship domain graph.

In some embodiments of the processor, the input is acquired from a user device associated with a user, and the processor is further configured to trigger display of the output on the user device.

In some embodiments of the processor, to trigger display further comprises the processor configured to trigger display of the intermediate output on the user device in addition to the output.

In some embodiments of the processor, to generate the instance graph comprises the processor configured to execute a single call to the LLM.

In at least one aspect of the present technology, there is provided a non-transitory computer-readable medium comprising instructions which upon being executed by a processor, cause the processor to: acquire an input indicative of a Relational Question-Answering (RQA) problem; generate, using a Large Language Model (LLM), an instance graph based on the input; generate an intermediate output indicative of one or more reasoning paths in the instance graph; and generate, using a reasoner and based on the input and the intermediate output, an output indicative of one or more potential answers to the RQA problem.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “user device” refers to any electronic device capable of receiving input and displaying output. This includes, but is not limited to, mobile devices, tablets, personal computers, and smart devices. In some embodiments, the user device comprises a display for presenting outputs to a user, such as potential answers to a Relational Question-Answering (RQA) problem. The display may be an integrated screen (e.g., a smartphone display) or an external monitor connected to the device.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates an exemplary pipeline comprising a graph extraction step, a reasoning path extraction step, and a reasoning step, in accordance with at least some non-limiting embodiments of the present technology.

FIG. 3A illustrates an example of kinship knowledge graph in a graph reasoner, in accordance with at least some non-limiting embodiments of the present technology.

FIG. 3B illustrates an example of a personalized knowledge graph in a graph reasoner, in accordance with at least some non-limiting embodiments of the present technology.

FIG. 4 is a scheme-block illustration of a method executable by a processor of the computing environment of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

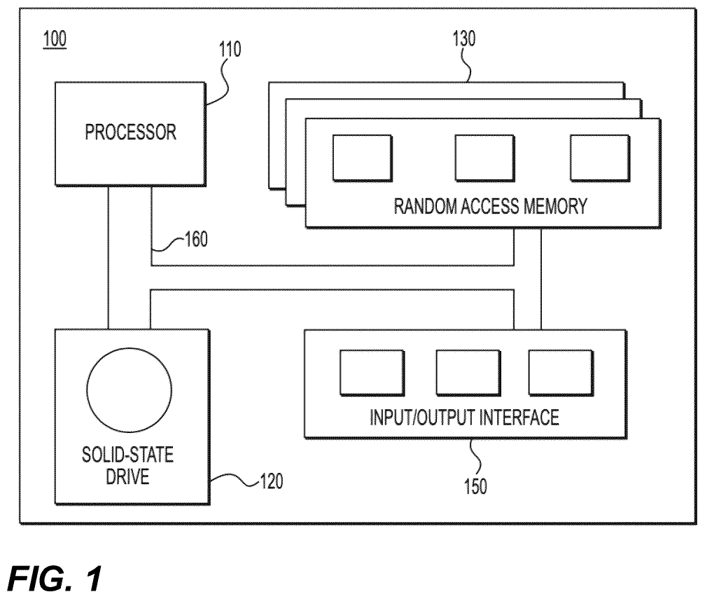

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

### Embodiment 1: Dynamic Reasoning Pipeline

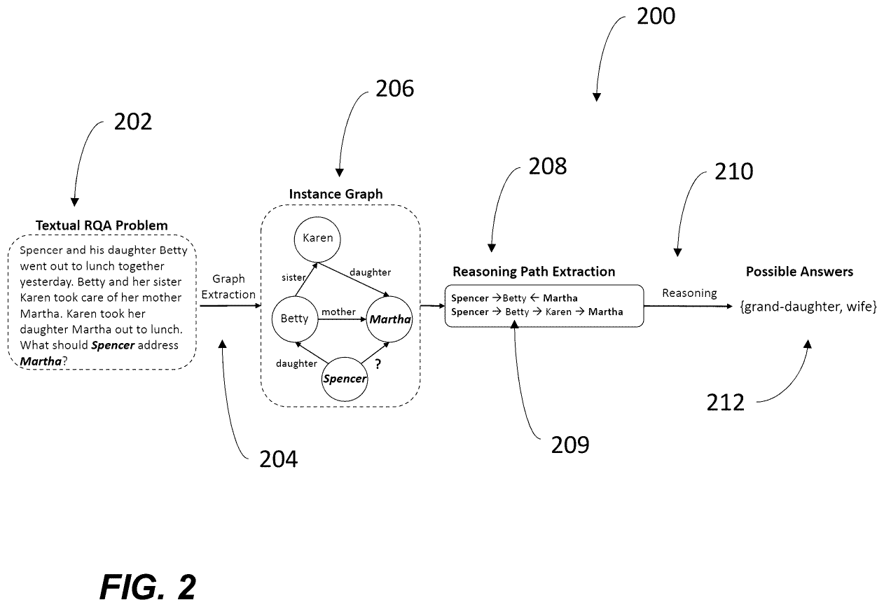

With reference to FIG. 2, there is depicted a processing pipeline 200 which is configured to employ a reasoner for a reasoning operation 210. The processor 110 may be configured to employ a graph reasoner, in addition to or instead of an LLM reasoner. The choice of reasoner can be dynamically made based on the nature of the RQA problem and the availability of relevant knowledge graphs. It is contemplated that the processing pipeline 200 may be executed by the computing environment 100 illustrated in FIG. 1. For example, one or more machine learning algorithms may be executed by the processor 100 as part of the processing pipeline 200.

In this embodiment, the processing pipeline 200 begins with the processor 110 configured to acquire data indicative of a textual RQA problem 202. For example, the processor 110 may acquire a user input in a natural language. In this non-limiting example, the textual RQA problem 202 is “Spencer and his daughter Betty went out to lunch together yesterday. Betty and her sister Karen took care of her mother Martha. Karen took her daughter Martha out to lunch. What should Spencer address Martha?”. Other textual RQA problems are also contemplated.

In this embodiment, the processor 110 may be configured to perform a graph extraction operation 204 on the textual RQA problem 202. Broadly, given a textual RQA problem s, a reasoner extracts an instance graph 206 and query expressed as a following problem: g, q=Reasoner(s). The graph g comprises a set of nodes V and edges E both of which can have attributes (e.g., gender, relation type, etc.). The query q identifies the entities v₁, v₂∈V which are in the question. To construct the graph, the reasoner is instructed to first identify the entities in the problem (e.g., persons), to extract all relations between entities mentioned in the story. For an embodiment in which the reasoner is an LLM reasoner, the extraction operation 204 is performed via a single LLM call to generate the instance graph 206. For an embodiment in which the reasoner is a graph reasoner, the extraction operation 204 involves identifying relevant nodes and edges in a pre-built knowledge graph.

In this embodiment, the processor 110 is configured to execute a reasoning path extraction operation 208 based on the instance graph 206 for generating one or more reasoning paths. Broadly, the processor 110 identifies all reasoning paths [p₁, p₂, . . . ] between the query nodes v₁, v₂∈V in the instance graph g. Each pᵢ consists of a sequence of edges which are connected by mutual object between adjacent edges. For example, the processor 110 may be configured to generate two reasoning paths 209.

In this embodiment, the processor 110 is configured to execute a reasoning operation 210 using one or more reasoning paths, such as the reasoning paths 209. Broadly, each reasoning path can be used independently by the processor 110 to infer a possible answer. During the reasoning operation 210, the processor may use the reasoner to infer all possible answers given all extracted reasoning paths: t=Reasoner([p₁, p₂, . . . ]). Each possible answer tᵢ ∈t can include an explanation about how it was inferred (e.g., including the reasoning paths). In this embodiment, the processor 110 is configured to generate two possible answers 212. For an embodiment in which the reasoner is an LLM reasoner, the answers are generated using the internal knowledge of the LLM. For an embodiment in which the reasoner is a graph reasoner, the answers are inferred from the explicit relationships stored within the knowledge graph.

It is contemplated that the potential answers may be contradictory to each other and allows for flexibility when ambiguities are present in the input RQA problem 202. In this non-limiting example, the possible answers 212 are “grand-daughter” and “wife”. Other possible answers are contemplated. During the reasoning operation 210, the processor 110 may rely solely on the internal knowledge of the reasoner for answer inference without a pre-defined ruleset and/or symbolic solver, and without departing from the scope of the present technology.

In this embodiment, the processor 110 may be configured to generate an output indicative of one or more of the possible answers 212 for display to a user associated with the inputted RQA problem 202.

In some embodiments of the present technology, the processor 110 may be configured to employ a graph reasoner, in addition to or instead of the LLM-based reasoner, for executing the reasoning operation 210.

### Embodiment 2: Graph Reasoner

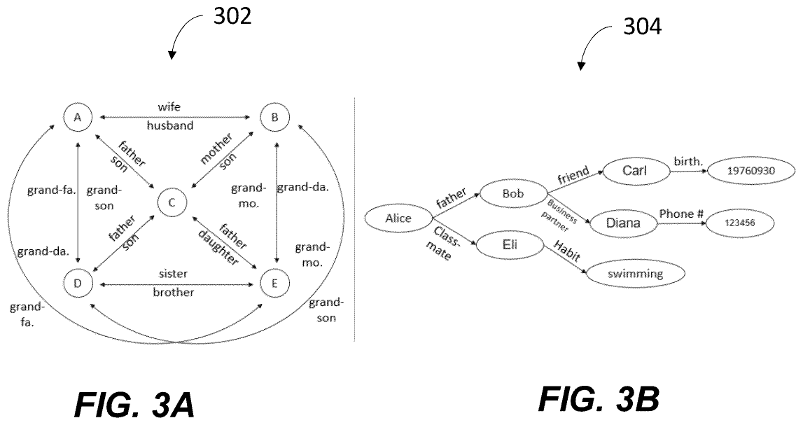

With reference to FIG. 3A and FIG. 3B, there is depicted a non-limiting example a kinship knowledge graph 302 and a non-limiting example of a personalized knowledge graph 304, respectively, and which the processor 110 may use for employing the graph reasoner in the other embodiment of the present technology. It is contemplated that a given graph reasoner may be employed instead of the LLM reasoner during the reasoning operation 210 of the processing pipeline 200 while executing the graph extraction operation 204 and the reasoning path extraction operation 208 in a similar manner to what has been described above.

Broadly, If the knowledge needed for inferring extracted reasoning paths [p₁, p₂, . . . ] is possessed in a pre-build knowledge graph, then a graph reasoner can be applied to identify more accurate answers. A given knowledge graph can be an abstract domain knowledge graph such as the graph 302, for example, or a personalized knowledge graph such as the graph 304, for example. Given a reasoning path p_{i∈}[p₁, p₂, . . .] and a given knowledge graph, a graph reasoning operation may be performed via a series of steps.

In this embodiment, during the graph reasoning operation, the processor 110 may be configured to identify a start node on the knowledge graph that represents the v₁ from the question. During the graph reasoning operation, the processor 110 may be configured to “follow” the follow the reasoning path pᵢ along the knowledge graph, until the processor 110 determines an end node on the knowledge graph that represents the v₂ from the question. During the graph reasoning operation, the processor 110 may be configured to output an answer. For example, the relationship between the starting node and the end node, and/or the information contained within the end node is then returned as the answer tᵢ for the reasoning path pᵢ.

It is contemplated that the processor 110 may be configured to execute the graph reasoning operation for all reasoning paths to acquire the final answer set t=[t₁, t₂, . . .] corresponding to reasoning paths [p₁, p₂, . . . ] (such as the reasoning paths 209, for example). The processor 110 may be configured to generate an answer set t (such as the possible answers 212, for example).

Developers of the present technology have realized that at least some embodiments of the present technology may be applied to resolve a wide range of “question-answering” problems that involve complex relationship reasoning. In one non-limiting implementation, question-answering capabilities of an intelligent personal assistant (IPA) system may be ameliorated with reasoning over the knowledge graph that is collected about the user and/or from user's local data. Broadly, an IPA system is designed to assist users by performing tasks or services based on voice, text, and/or other forms of input. Using modules for performing techniques such as natural language processing (NLP), and machine learning, IPA systems can understand and respond to user commands, provide information, manage schedules, and/or automate tasks. Common examples comprise virtual assistants like Siri™, Alexa™, and Google Assistant™, which integrate with devices and/or services to enhance productivity, offer recommendations, and/or streamline daily activities.

In this implementation, the processor 110 may generate the personalized knowledge graph 304 shown in FIG. 3B for a specific user employing the IPA system on his/her device. In one scenario, let it be assumed that the personalized knowledge graph 304 is generate by the processor 110. When the user asks a question such as “Tell me the phone number of my father's business partner,” to the IPA system, the processor 110 may be configured to generate a reasoning path: “Alice->father->business partner->phone number”. As a result, the IPA system may provide an answer with the extracted reasoning path and the personalized knowledge graph 304 for the given user.

Developers have realized that at least some embodiments of the present technology an LLM prompting-based pipeline may be executed and which (i) does not require extensive fine-tuning, (ii) is compatible with any RWA task in an “out-of-the-box” setting, (iii) enables fast inference with constant LLM calls (e.g., without varying a number of calls from one problem to another), and/or (iv) does not necessarily require symbolic solvers and/or complex rules.

Developers have realized that at least some embodiments of the present technology an LLM prompting-based pipeline may be executed and which is robust and/or interpretable. At least some embodiment may deal with potential problem ambiguities by isolating reasoning paths and/or inferring answers for each reason path independently. Each answer may be provided and/or associated with a reasoning path for interpretability purposes. As a result, this may enhance user experience with a given IPA system.

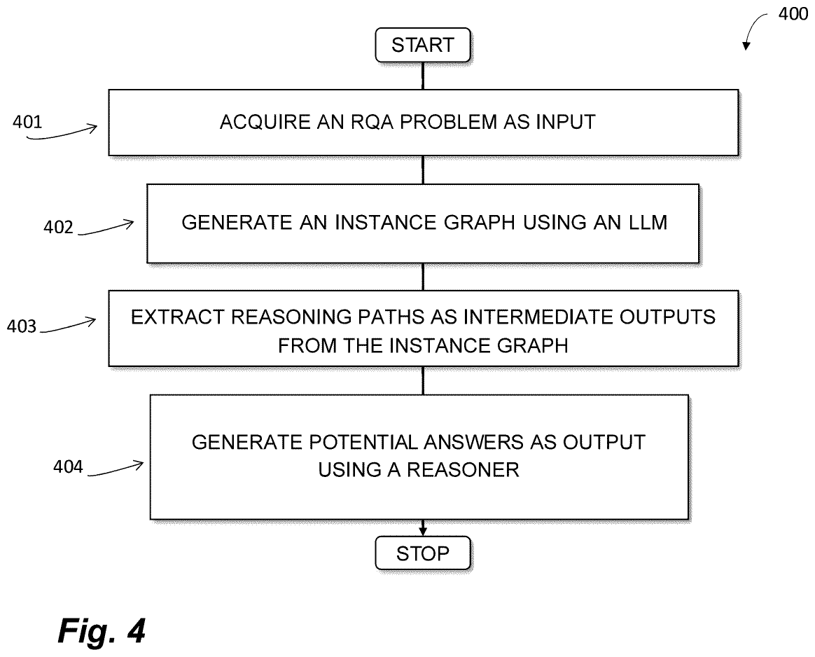

With reference to FIG. 4, there is depicted a scheme-block illustration of a method 400 executable by the processor 110 of FIG. 1. Various steps of the method 400 will now be described.

STEP 401: The method 400 starts with acquiring an input indicative of a Relational Question-Answering (RQA) problem. For example, the processor 110 of the computing environment 100 may be configured to acquire the textual RQA problem 202.

In some embodiments, the input is acquired from a user device, such as a mobile device, tablet, computer, or smart device. Such devices communicate with the computing environment 100 via the input/output interface 150. The user device may include a display for presenting outputs, such as possible answers 212 and explanations of reasoning paths 209. The input may include natural language queries that implicitly ask for the relationship between two entities mentioned in a story (e.g., “What is Alice's relation to Bob?”. In some embodiments, the input may also be accompanied by contextual information or personalized data from a personalized knowledge graph 304, as shown in FIG. 3B, influencing the reasoning paths 209.

STEP 402: The method 400 continues with generating, using a Large Language Model (LLM), an instance graph based on the input. For example, the processor 110 may be configured to generate the instance graph 206.

In some embodiments, the instance graph 206 is a structured representation of the RQA problem, where nodes represent entities and edges represent relationships between them. The query identifies the entities relevant to the RQA problem.

In some embodiments, the instance graph 206 is generated using a single call to the LLM. This is possible because the LLM is instructed to identify entities, extract all relations, and construct the instance graph in one pass, minimizing computation time and ensuring consistent outputs.

In some embodiments, the instance graph 206 is augmented with contextual information from a personalized knowledge graph 304, enhancing the relevance and accuracy of the extracted relations.

STEP 403: The method 400 continues with generating an intermediate output indicative of one or more reasoning paths in the instance graph. For example, the processor 110 may be configured to generate the reasoning paths 209 as the intermediate output. These paths are extracted during the reasoning path extraction operation 208 and are subsequently used in the reasoning operation 210 to generate potential answers 212.

STEP 404: The method 400 continues with generating, using a reasoner and based on the input and the intermediate output, an output indicative of one or more potential answers to the RQA problem. For example, the processor 110 may be configured to generate the potential answers 212 using the reasoner.

In some embodiments, the processor 110 may be configured to employ a graph reasoner, in addition to or instead of the LLM-based reasoner, for executing the reasoning operation 210.

For embodiments in which the processor 110 employs an LLM reasoner, the reasoning operation 210 is performed by leveraging the internal knowledge of the LLM to evaluate the reasoning paths 209. The LLM-based reasoner generates potential answers 212 the information and relationships identified in the instance graph 206.

For embodiments in which the processor 110 employs a graph reasoner, the reasoning operation 210 is performed by navigating through a pre-built knowledge graph, such as a domain knowledge graph 302 or a personalized knowledge graph 304. The graph reasoner follows the reasoning paths 209 to infer potential answers 212 from the relationships stored within the knowledge graph.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 400 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method executable by a processor, comprising:
acquiring an input indicative of a Relational Question-Answering (RQA) problem;
generating, using a Large Language Model (LLM), an instance graph based on the input;
generating an intermediate output indicative of one or more reasoning paths in the instance graph; and
generating, using a reasoner and based on the input and the intermediate output, an output indicative of one or more potential answers to the RQA problem.

2. The method of claim 1, wherein the reasoner is an LLM-based reasoner.

3. The method of claim 1, wherein the reasoner is a graph reasoner.

4. The method of claim 3, wherein the method comprises generating a knowledge graph for use by the graph reasoner.

5. The method of claim 4, wherein the knowledge graph is at least one of a domain knowledge graph and a personalized knowledge graph.

6. The method of claim 5, wherein the personalized knowledge graph is generated using user data specific to a given user.

7. The method of claim 5, wherein the domain knowledge graph is a kinship domain graph.

8. The method of claim 1, wherein the input is acquired from a user device, and the method further comprises:
displaying the output on the user device.

9. The method of claim 8, wherein the displaying further comprises displaying the intermediate output on the user device.

10. The method of claim 1, wherein the generating the instance graph is executed using a single call to the LLM.

11. A processor configured to:
acquire an input indicative of a Relational Question-Answering (RQA) problem;
generate, using a Large Language Model (LLM), an instance graph based on the input;
generate an intermediate output indicative of one or more reasoning paths in the instance graph; and
generate, using a reasoner and based on the input and the intermediate output, an output indicative of one or more potential answers to the RQA problem.

12. The processor of claim 11, wherein the reasoner is an LLM-based reasoner.

13. The processor of claim 11, wherein the reasoner is a graph reasoner.

14. The processor of claim 13, wherein the processor is further configured to generate a knowledge graph for use by the graph reasoner.

15. The processor of claim 14, wherein the knowledge graph is at least one of a domain knowledge graph and a personalized knowledge graph.

16. The processor of claim 15, wherein the personalized knowledge graph is generated using user data specific to a given user.

17. The processor of claim 15, wherein the domain knowledge graph is a kinship domain graph.

18. The processor of claim 11, wherein the input is acquired from a user device associated with a user, and the processor is further configured to:
trigger display of the output on the user device.

19. The processor of claim 18, wherein to trigger display further comprises the processor configured to trigger display of the intermediate output on the user device in addition to the output.

20. The processor of claim 11, wherein to generate the instance graph comprises the processor configured to execute a single call to the LLM.

21. A non-transitory computer-readable medium comprising instructions which upon being executed by a processor, cause the processor to:
acquire an input indicative of a Relational Question-Answering (RQA) problem;
generate, using a Large Language Model (LLM), an instance graph based on the input;
generate an intermediate output indicative of one or more reasoning paths in the instance graph; and
generate, using a reasoner and based on the input and the intermediate output, an output indicative of one or more potential answers to the RQA problem.
